(19) United States
(12) Patent Application Publication
(10) Pub. No.: US 2024/0320333 A1
(43) Pub. Date: Sep. 26, 2024

(54) Cyber Security System To Prevent Insider Attacks

(71) Applicant: Timothy William Edgin, Houston, TX (US)

(72) Inventor: Timothy William Edgin, Houston, TX (US)

(21) Appl. No.: 18/126,451

(22) Filed: Mar. 26, 2023

(51) Int. Cl. G06F 21/56

(52) U.S. Cl. CPC G06F 21/566; G06F 2221/034

(57) ABSTRACT

A cyber security system mainly designed to prevent insider attacks. A security importance number is assigned to each relevant object that the user wishes to protect. Then whenever a change is requested of a particular protected object, a security importance number threshold check is made and N+1 many administrators must approve of the change before the change is implemented.

### PRIOR ART

While there are systems available to detect insider attacks such as US 2021/0258336, the available prior art does nothing to prevent these insider attacks. There are also systems that are able to automatically remedy cyber security breaches such as US 2018/0159887, however these systems are normally implemented after system wide damage is done.

### BACKGROUND OF THE INVENTION

Cyber insurance risk currently stands at 40 billion in risk, and collected premiums are only 8.5 billion. Due to threat from Russia the current risk cannot be quantified due to the crossover of state and non-state actors in Russian ransom ware gangs.

The two greatest challenges facing cybersecurity today are insider threats, and state/non-state ransomware gangs. The present subject matter reduces both of these risks.

Currently, corporations rely on cybersecurity engineers, managers, and directors to maintain critical systems. The risk come when any one account or account owner belonging to these holders of the “Keys of the Kingdom” they can often do extensive damage beyond the scope of what a cyber insurance policy will cover.

### SUMMARY OF THE INVENTION

The present subject matter still has traditional Users and Administrator accounts as in an Active Directory. However, in the present subject matter, every object in the corporation is given a security importance number (5), for instance the standard could be N5 or a color-coded scheme (n to n+5).

This means objects with a classification of n require only one administrator to make changes to it, N+1 requires 2 administrators to make changes, and n+5, the most secure objects, require 6 administrators all concurrently agreeing the change should be made.

For Domain Controllers and SQL Databases N+3 could be the standard. For secret n documents N=5.

After each security importance number has been assigned to each relevant object in the company's technical infrastructure, whenever a system change request (10) is made, that approval threshold from the security importance number (5) must be meet within an approval time limit (15).

The predetermined and appropriate number of approved administrators then must each individually approve of the change within the approval time limit (15) for the change to be implemented system wide (20). These approval time limits are finite and user configurable.

If the security importance number threshold check (25) is exceeded by administrative consent and it is done within the approval time limit check (30), then the requested system change will be granted (20).

If the security importance number threshold check (25) of N+1 is not exceeded, then system change denied (35) will occur and the change to the system will not go through as requested.

If the security importance number threshold check (25) of N+1 is exceeded, but the then the approval time limit check (30) is not met, then system change denied (35) will occur and the change to the system will not go through as requested.

### DETAILED DESCRIPTION OF DRAWINGS

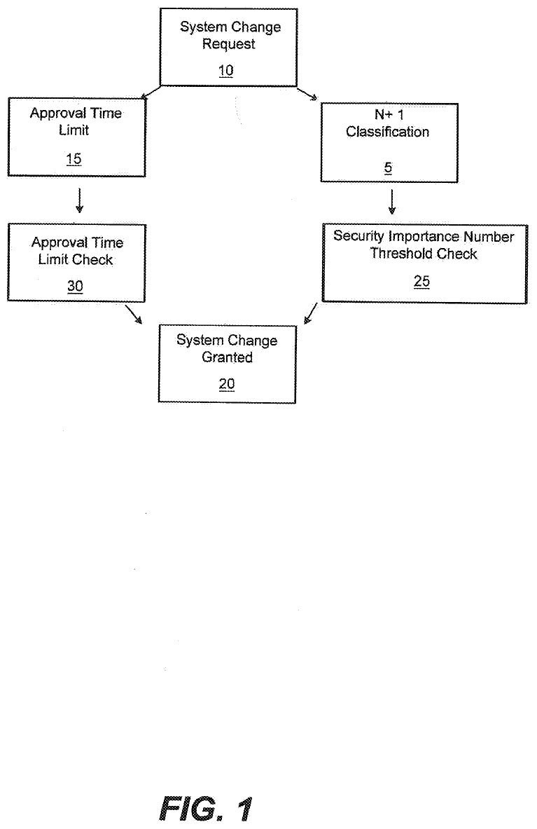

FIG. 1 depicts a flow chart which illustrates the order of operations regarding the cyber security system when the change is ultimately granted. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, the security threshold and approval time limit (15, 30) is met so the change is granted.

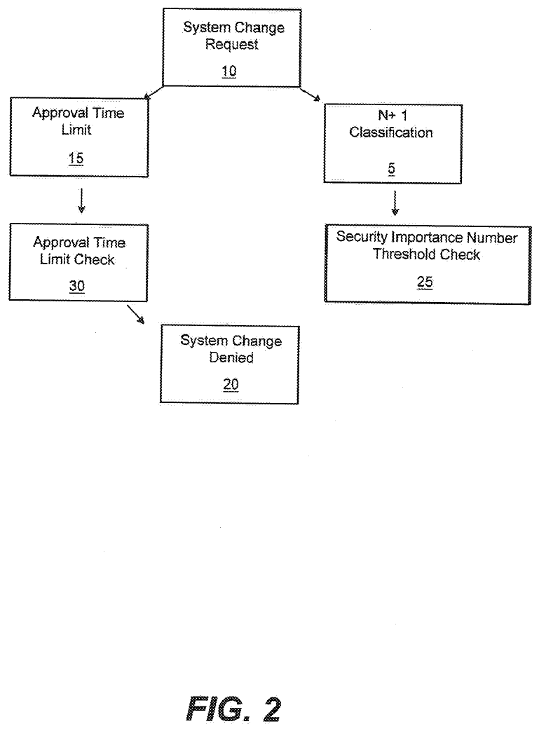

FIG. 2 depicts a flow chart which illustrates the order of operations regarding the cyber security system when the change is denied due to a failure to meet the security importance number threshold. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, the security threshold is not met, so the system change is denied.

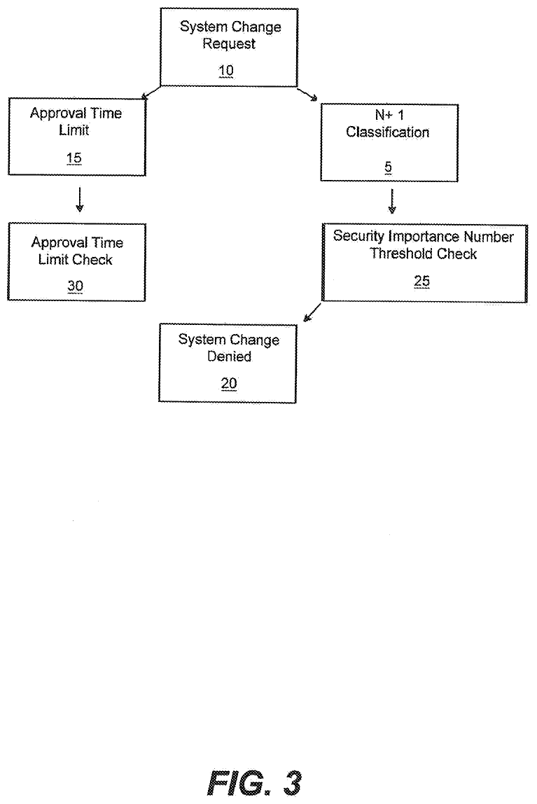

FIG. 3 depicts a flow chart which illustrates the order of operations regarding the cyber security system when the change is denied due to a failure to meet the approval time limit. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, while the security threshold is ultimately met, it was not met within the time limit.

1. A cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied.

2. The cyber security system primarily designed to prevent insider attacks wherein objects in the technical infrastructure of the company are assigned security importance numbers, system change requests are made, security importance number threshold checks are made, approval time limits are defined, approval time limit checks are made, and system changes are granted or denied as in claim 1, wherein an object is assigned an N+1 security importance number which determines the total number of administrators which approve of the system change.

3. The cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 1, wherein the security importance number threshold check is made to determine if the appropriate number administrators approve of the specific system change.

4. The cyber security system primarily designed to prevent insider attacks wherein objects in the technical infrastructure of the company are assigned security importance numbers, system change requests are made, security importance number threshold checks are made, approval time limits are defined, approval time limit checks are made, and system changes are granted or denied as in claim 1, wherein the approval time limit is defined to give administrators an appropriate amount of time to review the change that is being requested.

5. The cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 1, wherein if the security importance number threshold check and approval time limit check are both passed, the requested change is granted.

6. The cyber security system primarily designed to prevent insider attacks wherein objects in the technical infrastructure of the company are assigned security importance numbers, system change requests are made, security importance number threshold checks are made, approval time limits are defined, approval time limit checks are made, and system changes are granted or denied as in claim 1, wherein if either the security importance number threshold check or the approval time limit check is failed, then the system change is denied.

7. A method of using a cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied.

8. The method of using the cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 7, wherein an object is assigned an N+1 security importance number which determines the total number of administrators which approve of the system change.

9. The method of using the cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 7, wherein the security importance number threshold check is made to determine if the appropriate number administrators approve of the specific system change.

10. The method of using the cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 7, wherein the approval time limit is defined to give administrators an appropriate amount of time to review the change that is being requested.

11. The method of using the cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 7, wherein if the security importance number threshold check and approval time limit check are both passed, the requested change is granted.

12. The method of using the cyber security system primarily designed to prevent insider attacks wherein objects in the technical infrastructure of a company are assigned security importance numbers, system change requests are made, security importance number threshold checks are made, approval time limits are defined, approval time limit checks are made, and system changes are granted or denied as in claim 7, wherein if either the security importance number threshold check or the approval time limit check is failed, then the system change is denied.
